(19) United States
(12) Patent Application Publication
(10) Pub. No.: US 2022/0072456 A1
(43) Pub. Date: Mar. 10, 2022

(54) SYSTEM AND METHOD FOR CONDITION-BASED FILTER CHANGES

(71) Applicant: Poseidon Systems, LLC, Rochester, NY (US)

(72) Inventors: Alexander T. Pelkey, Rochester, NY (US); Timothy R. Marvin, Rochester, NY (US); Ryan C. Brewer, Webster, NY (US)

(73) Assignee: Poseidon Systems, LLC, Rochester, NY (US)

(21) Appl. No.: 17/017,384

(22) Filed: Sep. 10, 2020

(51) Int. Cl. B01D 35/143; B01D 37/04; B01D 35/26; B01D 35/00; B01D 35/147; F16H 57/04; F01M 11/10; F16N 39/06

(52) U.S. Cl. CPC B01D 35/143; B01D 37/043; B01D 35/26; B01D 35/005; B01D 35/147; F01M 11/0004; F16H 57/0404; F01M 11/10; F16N 39/06; B01D 2201/54; F16H 57/0436; F16H 57/0405

(57) ABSTRACT

A method and system for estimating the remaining useful life of a filter in a lubrication system is disclosed along with exemplary system components.

Described herein is a system and method for determining the remaining useful life of an oil or lubrication filter element, for example an oil filter element used with gearboxes, turbines, internal combustion engines, and other machinery that utilize positive displacement lube oil filtration systems.

### BACKGROUND AND SUMMARY

Mechanical systems and equipment frequently employ gearboxes, internal combustion engines, and turbines that require lubrication systems to lubricate moving components with oil, or similar lubricating fluids. Non-limiting examples of components that require such lubrication include, gears/gearing and bearings and similar mechanical components that are in contact with one another. The use of lubricating fluids protects such components from wear and corrosion, provides means of cooling, and flushes and removes contaminants from the components and the wear surfaces.

The embodiments disclosed herein are directed to a method for determining or estimating the remaining useful life (RUL) of a filter element. For example, estimating the remaining useful life of a filter element for oil or a similar lubrication fluid (including oils, emulsions (oil-water emulsions, dispersions, etc.), used in gearboxes, turbines, internal combustion engines, and other machinery or equipment that utilize positive displacement lubrication and/or oil filtration systems. The remaining useful life of such a filter may be calculated, in accordance with an embodiment disclosed herein, based upon a flow rate measurement of an oil line that diverts a representative flow of oil from the main filtration system, as well as taking system operation runtime into account.

Filter elements are most commonly changed based on system runtime or other time intervals. Time-based filter changes do not take machine health, oil quality, or other operational factors into consideration. As a result, time-based filter changes often cause either a filter to be changed before it is actually necessary or a filter change after the filter has reached its load capacity and is no longer providing adequate filtration to the lubrication fluid.

Previous attempts to remedy these issues have been attempted and some utilize a differential pressure measurement across the filter element to determine the remaining useful life of the filter. These solutions often require multiple sensors and oil ports to make their determination. Examples include US Publ. 2003/0226809 A1, U.S. Pat. Nos. 9,061,224, 9,776,114 and US Publ. 2016/0116392.

The method disclosed herein utilizes a different approach that is based upon a single flow rate measurement of a diverted lubrication line.

Disclosed in embodiments herein is a method for estimating the remaining useful life of a fluid (e.g. oil) filter, comprising: diverting fluid flow from a sample port, the sample port located between a main fluid pump and the filter, returning the diverted fluid to the fluid reservoir (sump); measuring, in real time, the flow rate of the diverted fluid at a first time (Q100) and a second time (Qn); and calculating the percent remaining useful life (% RUL) as a function of a diverted flow rate (e.g., the difference in the flow rate at the first time and the second, later, time).

Further disclosed in embodiments herein is a machine lubrication system for estimating the remaining useful life of a fluid (e.g., oil) filter in the system, comprising: a sump for holding fluid not in circulation; a fluid pump for pumping fluid; a fluid return line for returning unfiltered fluid to an inlet of the fluid pump, where an inlet of the fluid filter is attached to an outlet of the fluid pump and the outlet of the fluid filter is connected to a filtered fluid supply line to return filtered fluid for use in the machine; a sample port, fluidly connected to the outlet of the fluid pump (adapter), and to a fluid diversion loop suitable for diverting fluid flow and returning the diverted fluid to the sump; a device, located in-line with the fluid diversion loop, for measuring a flow rate of the diverted fluid at various times; and a processor configured to calculate the percent remaining useful life (% RUL) as a function of a flow rate of the diverted fluid.

### BRIEF DESCRIPTION OF THE DRAWINGS

FIG. 1 is a schematic view of an exemplary lubrication filtration system; and

FIG. 2 is a graphical representation of a calculated estimation of filter useful life in accordance with an aspect of the disclosed method.

The various embodiments described herein are not intended to limit the disclosure to those embodiments described. For purposes of illustration, the following disclosure of systems and methods for estimating the remaining useful life of a fluid are described in the context of a lubrication system, and even more specifically in some cases as lubrication system and reservoir for a gearbox or mechanical system. However, the examples used to illustrate the embodiments of the system and method are intended to be non-limiting. For example, reference to the fluid as a lubrication fluid are, unless otherwise stated, for purposes of illustrating an application of the disclosed embodiments and not to limit the scope of the disclosure. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

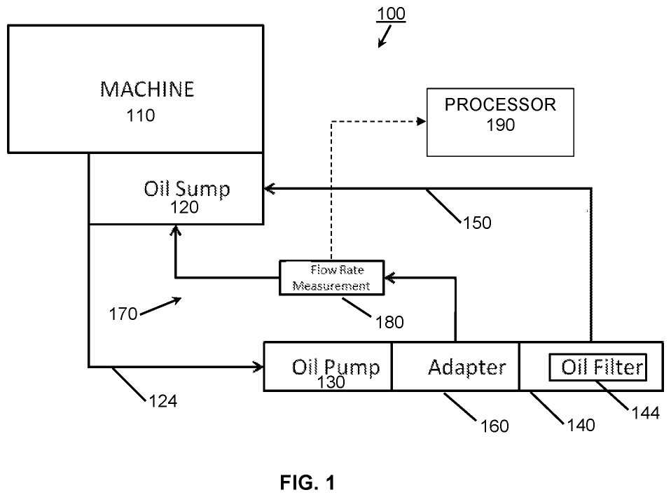

FIG. 1 is an illustration of an exemplary lubrication fluid (e.g. oil) filtration system 100 suitable for carrying out the methods disclosed herein. A filtration system 100 is generally associated with a machine or piece of equipment 110, and includes or consists of an oil sump 120, and the sump is sometimes the machine or equipment housing itself. Also included is a hydraulic inlet line 124 that feeds fluid from the sump 120 to a pump 130. In one embodiment the pump may be a positive displacement gear oil pump or any similarly configurable pumping mechanism. In a typical configuration, a filter housing 140 has a replaceable filter element 144 located therein, and the housing assures that the lubrication fluid pumped into the housing passes through the filter element to a hydraulic return line 150 that returns filtered oil to the machine 110, such as to the associated sump 120.

Also depicted as part of the filtration system of FIG. 1 is a filter bypass adapter or component 160 that will allow some amount of lubrication fluid to bypass the filter element.

In accordance with an aspect of the disclosed machine lubrication system 100, the system may include additional elements, such as a flow rate measurement device 180 providing data (e.g., flow rate information, Q) to a processor 190 for estimating the remaining useful life of the lubrication fluid (oil) filter in the system. Such a system comprises or consists of, as briefly noted above, a sump 120 for holding lubrication fluid not in circulation, a fluid return line 124 for returning unfiltered lubrication fluid to an inlet of the fluid pump 130 for pumping of the lubrication fluid. In the machine lubrication system the fluid pump 130 may include a positive displacement gear pump that operates at a constant flow rate during normal operation.

An inlet of the lubrication fluid filter housing 140, with filter 144 therein, is attached to an outlet of the fluid pump 130 using an adapter or similar component 160 having a diversion port. And, the outlet of the lubrication fluid filter housing 140 is connected to a filtered lubrication fluid supply line 150 to return filtered lubrication fluid for use in the machine 110. As noted, using the diversion feature of the adapter 160, a sample port of the adapter is fluidly connected to the outlet of the fluid pump, and to a fluid diversion loop 170 suitable for diverting a fraction of lubrication fluid flow and returning the diverted lubrication fluid to the sump. Included in the fluid diversion loop 170 is an in-line device 180 for measuring a flow rate of the diverted lubrication fluid at various times. The device 180 outputs the flow rate data, as illustrated by the dashed line, to a processor 190, which is configured to calculate a percent remaining useful life (% RUL) as a function of the measured flow rate of the diverted lubrication fluid passing through loop 170.

In the lubrication system 100, the flow rate is measured by device 180 at least at a first time (Q100), for example immediately after a filter change, and a second time (Qₙ), and using such measurements the remaining useful life (% RUL) is calculated by the equation:

% RUL=100*[1−((Qₙ−Q₁₀₀)/(Q₀−Q₁₀₀))], Eq. 1

where Qₙ is the current flow rate, Q₁₀₀ is the flow rate with a new filter, and Q₀ is a flow rate with a completely used filter. In an alternative method of determining Q₀, the system could be simulated and Q₀ could be determined by calculating the bypass flow rate at the point right before the filter would go into bypass based on the pressure drop. Additionally, the simulation estimate of Q₀ could be refined using empirically collected data. And, the Q₀ value could also be empirically determined by collecting bypass flow rate data during a full filter life cycle. While the calculation of remaining useful life is of value, it is also possible to employ the disclosed system and method in a manner suitable for simply characterizing filter degradation. In other words, monitoring for a change in flow rate as an indication of filter degradation, instead of actually calculating remaining useful life. Another application for the disclosed system and method would be for detection of filter media breakdown in a machine lubrication system. For example, when a filter is not changed for a significant period of time, eventually, depending on filter media type, the filter medium (e.g., fibers) will begin breaking down. This type of filter degradation would be detected as a drop or reduction in flow rate in the fluid diversion or bypass line 170. The same may be observed for the bypass valve opening, but would depend on the bypass valve construction as to whether backpressure would drop after opening or remain constant.

Those having knowledge of such machine lubrication systems will appreciate that various components (e.g., pumps, filters (incl. housings and replaceable filters) may be suitable for use in the disclosed lubrication system. However, one component contemplated in an embodiment of the machine lubrication system 100 is an inductive wear debris sensor to be employed as the device 180 used for measuring the flow rate of the diverted lubrication fluid. The conditions of measuring flow rate as it relates to the system and method described herein may be satisfied by a sensor for monitoring the number of particles and/or debris (e.g., metallic particles due to component wear) contained within the lubrication fluid (oil). Output from such a sensor may include, among other characteristics, fluid flow rate (Q), particle count, particle size, particle category (ferrous/nonferrous), etc. Sensors suitable for monitoring of wear debris include one or more debris sensing technologies, such as the Poseidon Systems Trident line of sensors, as well as optical debris sensing techniques, inductive coil technologies, ultrasonic technologies, magnetometry and/or electromagnetic technology to determine characteristics of the wear particles contained within the lubricating fluid. As will be appreciated the debris sensor may employ any method for determining flow rate as well as counting and sizing individual debris (e.g., metal) particles, or any sensing technology for measuring or estimating material loss.

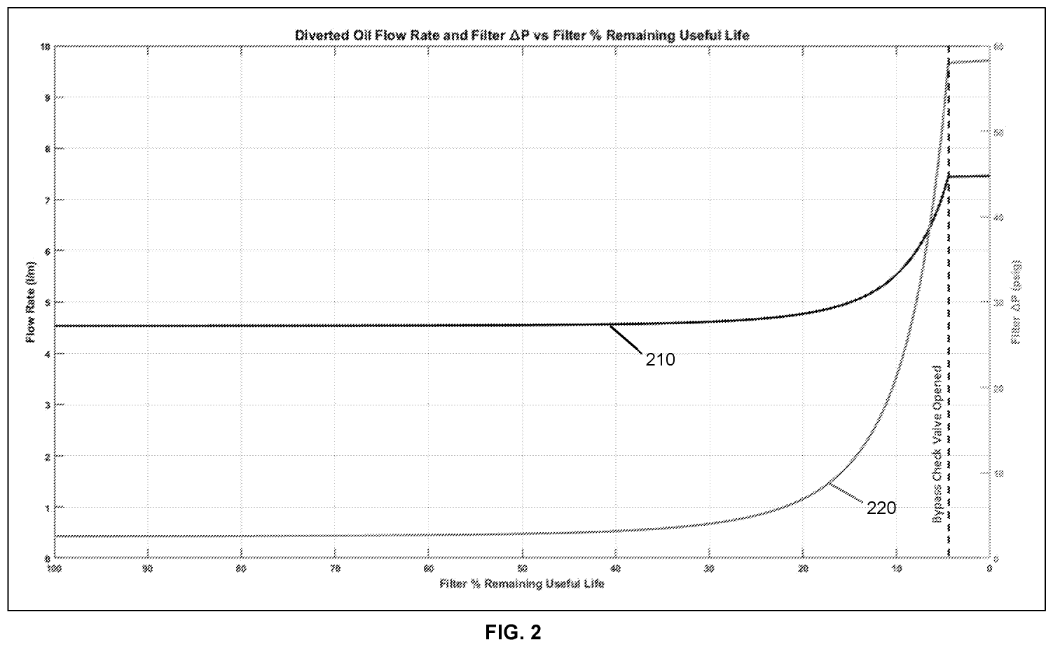

Having described an exemplary system for monitoring and determination of the remaining useful life of a lubrication fluid filter, attention is now turned to the method(s) employed in determining the estimated useful filter life. Also referring to FIG. 2, depicted therein is a graph illustrating the diverted oil flow rate (210) and associated filter pressure change (220) relative to the filter percentage of remaining useful life.

A method for estimating the remaining useful life of a lubrication fluid (oil) filter, comprises or consists of at least the operations of diverting lubrication fluid (oil) flow from a sample port, the sample port located between a pump such as a main gearbox lubrication fluid pump and the filter, as described relative to FIG. 1, and returning the diverted lubrication fluid to a reservoir. The method further includes measuring, in real time, the flow rate of the diverted lubrication fluid at at least a first time (Q₁₀₀) and a second time (Qₙ), and then using a processor of similar computational device calculating the percent remaining useful life (% RUL) as a function of a diverted flow rate (e.g., the difference in the flow rate at the first time and the second, later, time).

More specifically, the calculation may be made in accordance with Equation 1 above. The disclosed method further contemplates that the measured real time flow rate (Q) at any particular time is proportional to a pressure drop across the filter, particularly where the pressure drop across the filter increases as a filter load increases due to loading (clogging) of the filter. In other words, the measured real time flow rate of the diverted lubrication fluid increases as the filter load increases.

Also, the method described herein contemplates the flow rate of the diverted lubrication fluid being measured using an inductive wear debris sensor. And, the inductive wear debris sensor may measure flow rate based on the time period of the signal generated by a metallic particle passing through a sensing field. At the same time, measurements obtained from the inductive wear debris sensor may also be used to estimate a cumulative metallic mass present in the lubrication fluid so as to concurrently determine and track the level or amount of such particles over time. A total metallic cumulative mass that has been filtered can also, using the processor 190, be estimated as a function of the metallic cumulative mass detected by the inductive wear debris sensor. For example:

Filter Mass Estimate=Bypass Mass*Scaling Factor, Eq. 2

where remaining useful filter life is projected based on the filter mass load capacity and the estimated total metallic cumulative mass since the last filter change.

RUL %=(Filter Mass Load Capacity−Filter Mass Estimate)÷Filter Load Capacity. Eq. 3

The basic premise is that it is possible to estimate the total cumulative mass of material in the filter based on the cumulative mass detected in a bypass line. The scaling factor applied is simply the proportion of flow through the filter. In other words, if the debris sensor detects 1 gram of material and 10% of the nominal system flow rate is going through the sensor and 90% is going through the filter, the scaling factor would be 9.

The second step would then use the calculated filter mass and the Filter Load Capacity (generally available from the filter manufacturer) to calculate a % RUL per Equation 3. In other words, if the filter can hold 10 grams and the filter is estimated to have captured 5 grams using Equation 2 above, then the % RUL would be 50% per Equation 3.

A caveat to this method of determining remaining useful life is that the method only accounts for metallic debris, which is only a portion of the total mass that is expected to be captured by the filter. While difficult to determine exactly what proportion of the debris caught by any given filter will be metallic versus non-metallic, the relative proportions may be empirically or statistically derived on an application to application basis. Moreover, this method of remaining useful life calculation can be used in coordination with the other % RUL calculation described to derive a “combined” % RUL estimate that takes each calculation into consideration. This combined % RUL would consist of a weighted average of the other % RULs, and it would be anticipated that some calculation methods would be considered more heavily than others.

In addition, processor 190 may employ an alternative regression equation that may be adjusted or specific to the system that is being modeled. System parameters like fluid viscosity, nominal temperature, filter bypass pressure, inlet/outlet orifice size, filter capacity, filter beta value, and nominal pump flow rate may all factor into what the representative regression should be. In some cases, that regression may be the linear equation above and in other cases an exponential or stepwise regression may be more appropriate. It will be appreciated that pressure differentials, a scaling factor(s) and other modifications could actually be used in the modeling of the filter to determine the regression rather than the actual equation itself in order to improve the accuracy of the estimated remaining useful life percentage.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A method for estimating the remaining useful life of a fluid filter, comprising:
diverting fluid flow from a sample port, the sample port located between a fluid pump and the filter,
returning the diverted fluid to a fluid reservoir;
measuring, in real time, the flow rate of the diverted fluid at a first time (Q₁₀₀) and a second, later, time (Qₙ); and
calculating the percent remaining useful life (% RUL) as a function of a diverted flow rate as a function of the difference in the flow rate at the first time and the second time.

2. The method according to claim 1, wherein the remaining useful life (% RUL) is calculated by the equation:
% RUL=100*[1−((Qₙ−Q₁₀₀)/(Q₀−Q₁₀₀))],
where Qₙ is the current flow rate, Q₁₀₀ is the flow rate with a new filter, and Q₀ is the flow rate with a completely used filter.

3. The method according to claim 1, wherein the remaining useful life is calculated using a processor employing a regression equation, where the regression equation is adjusted based upon at least one filter system parameter selected from the group consisting of: fluid viscosity, nominal temperature, filter bypass pressure, inlet orifice size, outlet orifice size, filter capacity, filter beta value, nominal pump flow rate, pressure differential, and a scaling factor.

4. The method according to claim 1, wherein the remaining useful life is calculated using a processor employing an equation selected from the group consisting of: linear regression, exponential regression, and stepwise regression.

5. The method according to claim 1, wherein the main gearbox lubrication oil pump is a positive displacement gear pump that operates at a constant flowrate during normal operation.

6. The method according to claim 1, wherein the measured real time flow rate (Q) at any particular time is proportional to a pressure drop across the filter.

7. The method according to claim 6, wherein the pressure drop across the filter increases as a filter load increases due to loading (clogging) of the filter.

8. The method according to claim 7, wherein the measured real time flow rate of the diverted lubrication fluid (oil) increases as the filter load increases.

9. The method according to claim 1, wherein the flow rate of the diverted lubrication fluid is measured using an inductive wear debris sensor.

10. The method according to claim 9, wherein the inductive wear debris sensor measures flow rate based on the period of the signal generated by a metallic particle passing through a sensing field.

11. The method according to claim 9, where measurements obtained from the inductive wear debris sensor measurements are also used to estimate a cumulative metallic mass present in the lubrication fluid over time.

12. The method according to claim 11, where a total metallic cumulative mass that has been filtered is estimated as a function of the metallic cumulative mass detected by the inductive wear debris sensor.

13. The method according to claim 11, where a total metallic cumulative mass that has been filtered is used to estimate remaining useful life of the filter based on filter load capacity.

14. A machine lubrication system for estimating the remaining useful life of a lubrication fluid (oil) filter in the system, comprising:
a sump for holding lubrication fluid not in circulation;
a fluid pump for pumping lubrication fluid;
a fluid return line for returning unfiltered lubrication fluid to an inlet of the fluid pump, where an inlet of the lubrication fluid filter is attached to an outlet of the fluid pump and the outlet of the lubrication fluid filter is connected to a filtered lubrication fluid supply line to return filtered lubrication fluid for use in the machine;
a sample port, fluidly connected to the outlet of the fluid pump (adapter), and to a fluid diversion loop suitable for diverting lubrication fluid flow and returning the diverted lubrication fluid to the sump;
a device, located in-line with the fluid diversion loop, for measuring a flow rate of the diverted lubrication fluid at various times; and
a processor configured to calculate the percent remaining useful life (% RUL) as a function of a flow rate of the diverted lubrication fluid.

15. The machine lubrication system of claim 14, where flow rate is measure by the device at least at a first time (Q₁₀₀) and a second time (Qₙ), and wherein the remaining useful life (% RUL) is calculated by the equation:
% RUL=100*[1−((Qₙ−Q₁₀₀)/(Q₀−Q₁₀₀))],
where Qₙ is the current flow rate, Q₁₀₀ is the flow rate with a new filter, and Q₀ is a flow rate with a completely used filter.

16. The machine lubrication system of claim 14, wherein the fluid pump is a positive displacement gear pump that operates at a constant flowrate during normal operation.

17. The machine lubrication system of claim 14, wherein the device for measuring the flow rate includes an inductive wear debris sensor for measuring the flow rate of the diverted lubrication fluid.
